(19) United States
(12) Patent Application Publication
(10) Pub. No.: US 2013/0179793 A1
(43) Pub. Date: Jul. 11, 2013

(54) ENHANCING VISUALIZATION OF RELATIONSHIPS AND TEMPORAL PROXIMITY BETWEEN EVENTS

(71) Applicant: International Business Machines Corporation, Armonk, NY (US)

(72) Inventors: Matthew E. Duggan, Chertsey (GB); Daniel Martin, Pawling, NY (US)

(73) Assignee: INTERNATIONAL BUSINESS MACHINES CORPORATION, Armonk, NY (US)

(21) Appl. No.: 13/780,639

(22) Filed: Feb. 28, 2013

Related U.S. Application Data
(63) Continuation of application No. 12/535,845, filed on Aug. 5, 2009.

(51) Int. Cl. G06F 3/0484

(52) U.S. Cl. CPC G06F 3/0484
USPC 715/736

(57) ABSTRACT

Components and functionality can be implemented in an event management application to display events along a timeline. A display interval earl be configured for the timeline and a scroll bar can allow scrolling to view different time periods on the timeline. In addition, filters may be applied to the events, so that relationships between events may be visualized. For example, the events may be filtered by network resource name, so that groups of events related to each network resource can be grouped together along the timeline.

### RELATED APPLICATIONS

This application claims the priority benefit of U.S. application Ser. No. 2/535,845 filed Aug. 5, 2009.

### BACKGROUND

Embodiments of the inventive subject matter generally relate to the field of network monitoring, and more particularly to enhancing visualization of relationships and temporal proximity between events.

Network management applications typically develop network models, collect historical data, perform trending and event processing, and include notification and visualization capabilities. Users typically view collected events in an operating- system-native or web-based application. These applications typically display the collected events in a table-like list that color-codes the events based on a perceived importance of the event. For example, green events may represent a “cleared” or “resolved” situation, such as SNMP link-up traps for device ports or interfaces. The events displayed in the list may contain information about the cause of the event or alarm.

### SUMMARY

Embodiments include a method directed to an event management unit receiving a plurality of network events from one or more devices on a network. In some embodiments, if attributes of the plurality of network events match criteria indicated in one or more filters, the plurality of network events can be grouped in accordance with the one or more filters. A first time and a second time can be determined for each of the plurality of network events. The first and second times can represent arrival of events, status changes, event start times, event end times, first occurrence of events, and last occurrence of events, etc. The grouped network events can be displayed, in a network event viewer, along a timeline based on the first and second times.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of displaying filtered events on a timeline.

FIG. 2 is a flow depicting example operations for displaying filtered network events along a timeline.

FIG. 3 is an example conceptual diagram of an alternative embodiment of a network event viewer.

FIG. 4 is a flowchart depicting example operations for creating a customer filter.

FIG. 5 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In other instances, well-known instruction instances, protocols, structures, and techniques have not been shown in detail in order not to obfuscate the description.

Event management applications display the events in a table-like list that may be configured to sort events based on an attribute (e.g., a time stamp, a resource name, an event time etc.). Although the list can be sorted by the event attributes, the temporal relationships between events may not be effectively visualized. Consider a scenario where several network devices are generating similar sets of events. In event management applications, the events would typically be presented in either time-of-arrival order or by an attribute such as a device name. In either case, the relationship between individual events within a set and the relationship between sets of events may not be adequately visually represented.

Components and functionality can be implemented in an event management application to display events along a timeline. A display interval can be configured for the timeline and a scroll bar can allow scrolling to view different time periods on the timeline. In addition, filters may be applied to the events, so that relationships between events may be visualized, For example, the events may be filtered by network resource name, so that groups of events related to each network resource can be grouped together along the timeline. As another example, a filter may also take into account topology data so to group events relating to a particular network services, such as a virtual private networks (VPN), Voice over Internet Protocol (VoIP) services, etc.

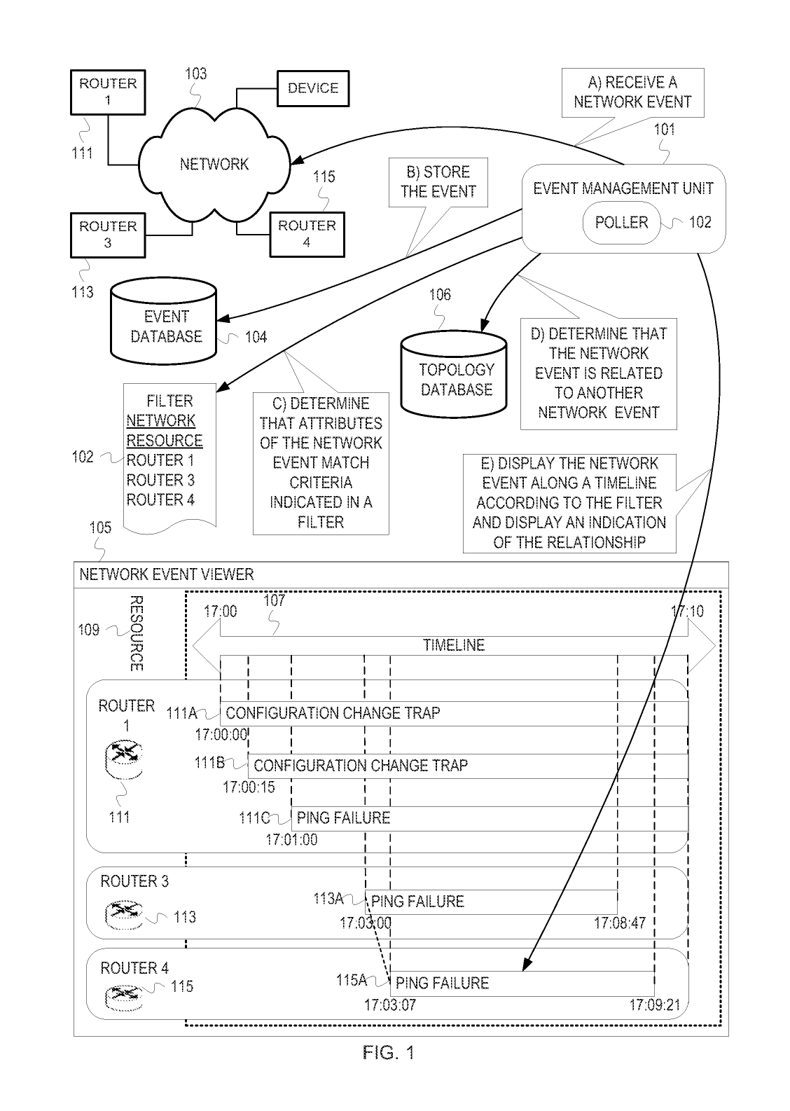

FIG. 1 is an example conceptual diagram of displaying filtered events on a timeline. At stage A, an event management unit 101 receives a network event from a network 103. Examples of network events include network device configuration changes, down links, ping failures, etc. Network events may be generated directly by network resources. For example, a router generates a Simple Network Management Protocol (SNMP) trap when the router detects a failure of the router's backup power supply. Network events may also be generated indirectly by a poller 102. The poller 102 can poll network resources and use the results of the polling to generate network events if a predefined threshold is crossed, a particular value is returned, etc. For example, an event may be generated for a network device if results of a poll show that the temperature of the device is ten percent greater than the temperature at a previous poll. Although the poller 102 is depicted as part of the event management unit 101, the potter 102 may be separate from the event management unit 101.

At stage B, the event management unit 101 stores the event in an event database 104. The event database 104 can store all received network events.

At stage C, the event management unit 101 determines that the network event attributes match criteria indicated in a filter 102. A filter can group related network events on the timeline. Filters may be defined by a user or my include default definitions. In one embodiment, a filter is defined to group network events originating from a particular segment of the network. Other examples of filter criteria include network resource names, network locations, event types, levels of urgency, etc. In addition, filters may leverage network topology data to group network events based upon relationships between network devices. For example, network events received from network devices providing VoIP service may be grouped together.

At stage D, the event management unit 101 determines if the network event is related to another network event based on topological data in a topological database 106. In this example, router 4 may be connected to router 3. So, if router 3 fails, router 4 is not available. The topological data can be collected by a network discovery engine when the event management unit 101 is started. The network discovery engine may periodically query the network to update the topological data if the network changes.

At stage E, the event management unit 101 displays the network event in a network event viewer 105, along a timeline 107 according to the filter. The event management unit 101 also displays an indication of the relationship. In this example, network events 113A and 115A are connected by a dotted line. The dotted line indicates a relationship between router 3 and router 4. The event management unit 101 may have received events that are not displayed in the network event viewer because event attributes may not have matched filter criteria. The event management unit 101 can query the event database 104 to retrieve events for display. For example, the event management unit 101 may query the database 104 to retrieve events when a new filter is selected. As another example, the event management unit 101 may query the database 104 to retrieve additional events when filter criteria changes,

In this embodiment, the timeline 107 is presented on the x-axis and the timeline window is ten minutes. The timeline window may be configured by a user. Default timeline windows may be provided for commonly used intervals (e.g., one minute, thirty minutes, one day, etc.). In addition, the timeline can allow scrolling to display different time periods along the timeline. In this embodiment, network events 111A, 111B, 111C, 113A, and 115A are filtered by network resource name, Network resource names are presented along the y-axis. The “configuration change trap” network event 111A, the “configuration change trap” network event 111B, and the “ping failure” network event 111C are grouped together because the network events 111A, 111B, and 111C originated from router 1 (see 111 in FIG. 1). The “ping failure” network event 113A originated from router 3 (see 113). The “ping failure” network event 115/\ originated from router 4 (see 115).

The beginning of each network event 111A, 111B, 111C, 113A, and 115A is vertically aligned with a particular time on the timeline, Network event 111A began at 17:00:00, network event 111B began at 17:00:15, network event 111C began at 17:01:00, network event 113A began at 17:03:00, and network event 115A began at 17:03:07. The end of each network event, if visible, is also vertically aligned with a particular time. The end times of network events 111A, 111B, and 111C are not visible in the current time interval. The network event 111A ends at 17:08:47, and the network event 115A ends at 17:09:21. In this example, the events are displayed based on start and end times of the events. in other examples, the events may be displayed based on timestamps that represent arrival of events, first and last occurrence of events, status changes, etc.

Although not shown in FIG. 1, more network events may have been received than can be displayed on a page. A scroll bar may allow vertical scrolling to additional network events. In addition, network events may be color-coded to indicate severity or importance. A summary of a network event's attributes may be displayed in response to a specific input (e.g., a right-click, a mouse-over, etc.). In addition, a panel or window can display a list of available filters. A user may choose to display events according one or more of the available filters.

Although examples refer to an event management unit receiving events originating from routers, embodiments are not so limited. The event management unit may receive events originating from other network devices such as printers, switches, servers, etc.

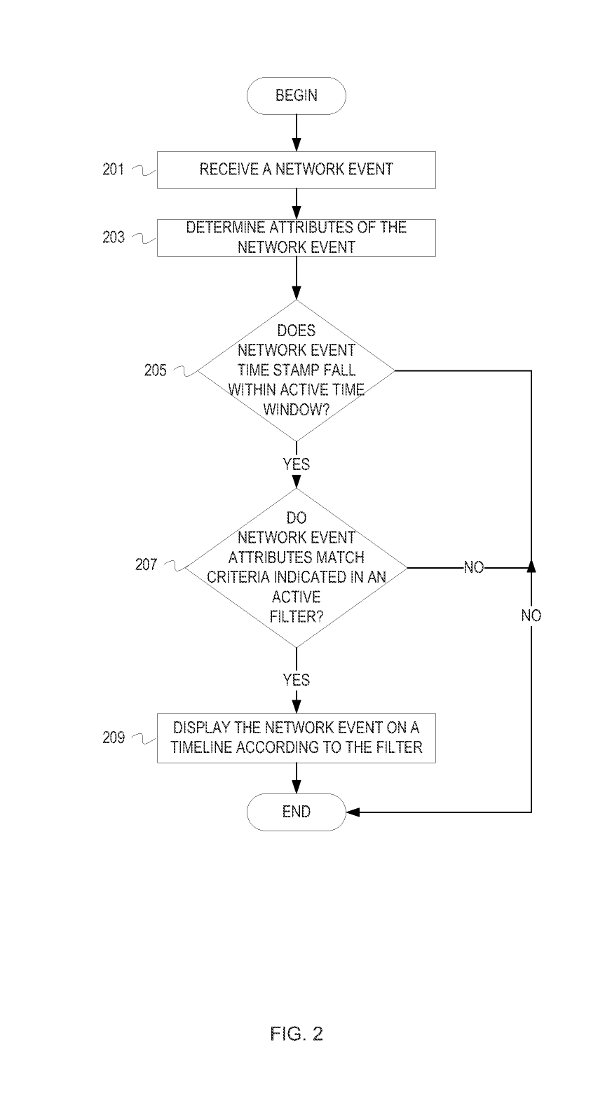

FIG. 2 is a flow depicting example operations for displaying filtered network events along a timeline. Flow begins at block 201, where an event management unit receives a network event. The network events may be received from a network as the events occur. Network events may also be received from a database. For example, the event management unit 101 receives events and stores them in a database. After the network event viewer 105 is launched, the event management unit can query the database for stored network events. Flow continues at block 203.

At block 203, the event management unit determines attributes of the network event. Attributes can include timestamps, network resource names, event types, failure information, network locations, etc. Flow continues at block 205.

At block 205, the event management unit determines if the network event's timestamp falls within an active time window being displayed in a network event viewer. Timestamps may represent arrival of events, status changes, event start times, event end times, first occurrence, and last occurrence, etc. If the network event timestamp does fall in the active time window, flow continues at block 207. If the network event timestamp does not fall in the active time window, flow ends.

At block 207, the event management unit determines if the network event attributes match criteria indicated in an active filter. Active filters can be selected by a user from a panel listing available filters. If the network event attributes match criteria indicated in the active filter, flow continues at block 209. If the network event attributes do not match criteria indicated in the active filter, flow ends.

At block 209, the event management unit displays the network event on a timeline, in a network event viewer, according to the filter, and flow ends. For example, network events originating from network resources belonging to a particular network segment are displayed. In some embodiments, the event management unit determines a start time and end time for the network event. In turn, the event management unit displays the event in a manner that indicates the event's start and end times (e.g., see 113A of FIG. 1).

More than one filter can be active for displaying network events. For example, network events can be filtered by network segment and by a network resource name. So, the network events originating from network resources belonging to a particular network segment may be organized by network resource names in a network event viewer.

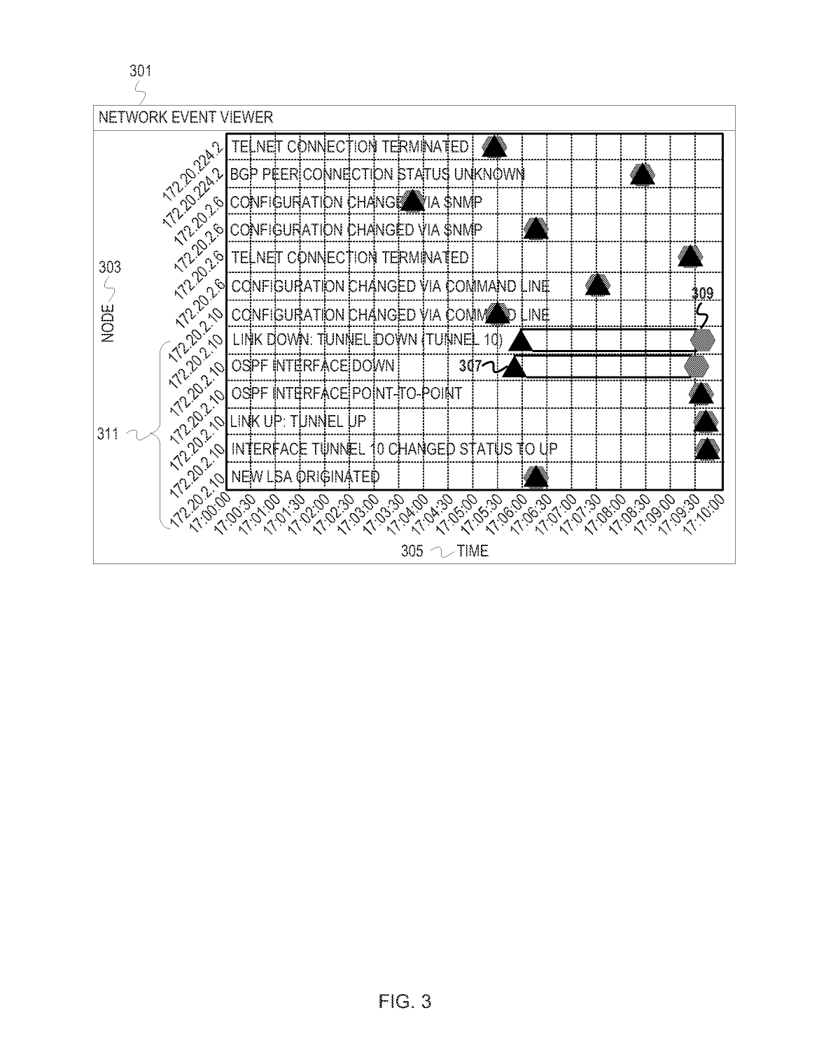

FIG. 3 is an example conceptual diagram of an alternative embodiment of a network event viewer. The network event viewer 301 comprises a timeline 305 on the x-axis and a node list 303 on the y-axis. In this example, the time window is ten minutes and the timeline 305 is divided into thirty-second intervals. The time window may be configured to display any suitable time period. In this example, network addresses are displayed on the y-axis and events are grouped according to network address, In other examples, the events may be grouped based on other properties such as relationships, event types, levels of urgency, etc. In addition, a subset of network events may be displayed according to one or more filters. For example, the filter indicates that network events associated with particular network services should be displayed while other network events should not be displayed.

A triangle 307 marks the start of each network event and a hexagon 309 marks the end of each network event. If the network events are short in duration, the triangle 307 may be displayed on top of the hexagon 309. If the network events are long in duration, the triangle 307 and the hexagon 309 are connected by lines. In addition, the triangle 307 and the hexagon 309 may be color-coded to indicate severity or importance of the corresponding network event. Multiple timestamps may be associated with events, so the triangle 307 and/or the hexagon 309 may represent other-time based properties. For example, the triangle 307 and the hexagon 309 may represent the first and last state change of a network resource, respectively. As another example, the triangle 307 and the hexagon 309 may represent the first and last occurrence of an event, respectively.

Scrolling may be available for both the x-axis and y-axis. Scrolling along the x-axis can display different time periods in the timeline 305. Scrolling along the y-axis can display additional network events. In addition, a network event may be paused. Pausing a network event can cause the event to stay visible while the x-axis and/or y-axis are scrolled. Also, an entire display may be paused so that the timeline remains at a particular time window rather than advancing the time window to display new network events as the new network events are being received. When an event and/or the entire display is un-paused, the display may advance to a most recent time window.

Network events in group 311 originated from network address 172,20.2.10. Grouping network events can help users visualize causal relationships between network events. The series of network events in group 311 are related to the “configuration changed via command line” network event that occurred at 17:05:30. Each of the other network events occurred due to the configuration change.

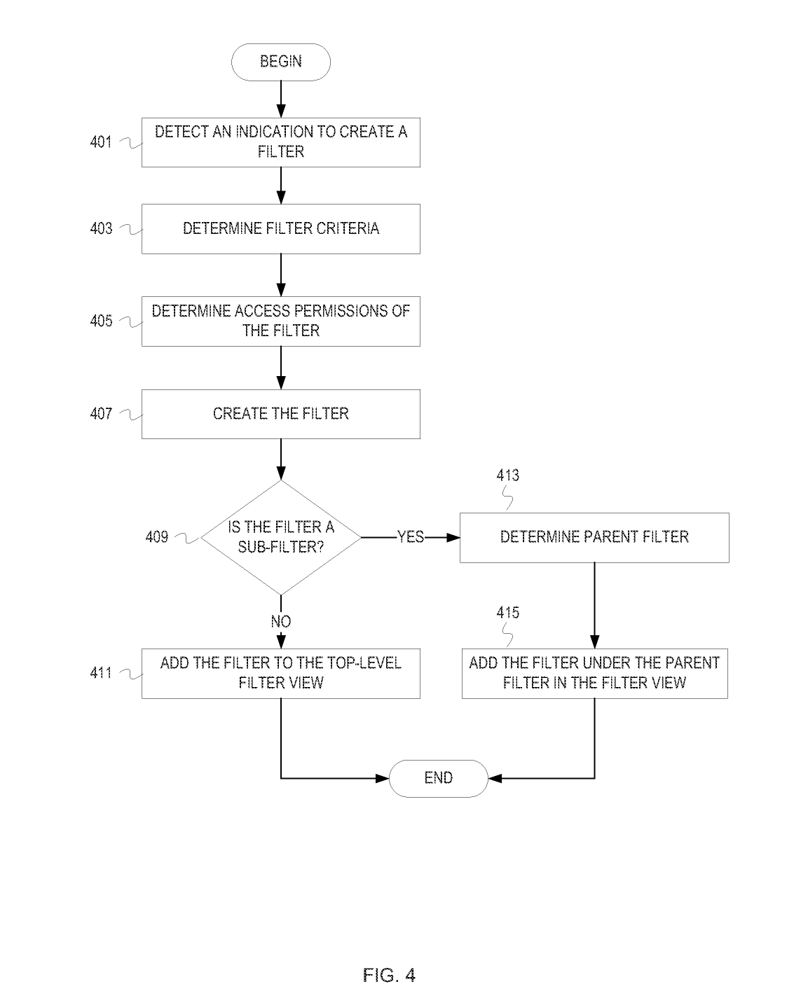

Although a network event viewer may have predefined filters, a user may wish to create a custom filter for a specific purpose, such as network node testing. FIG. 4 is a flowchart depicting example operations for creating a customer filter. Flow begins at block 401, where an event management unit detects an indication to create a filter. For example, the event management unit detects a click on a “create filter” button. Flow continues at block 403.

At block 403, the event management unit determines filter criteria. The event management unit can determine filter criteria based on user input. For example, the user selects values to be used to filter attributes of incoming events. The values may include network locations, network resource identifiers, levels of urgency, event types, network resource type, etc. Flow continues at block 405.

At block 405, the event management unit determines access permissions of the filter. Filters may be shared among network administrators. The access permissions can indicate which network administrators can use the filter. Flow continues at block 407.

At block 407, the filter is created. Flow continues at block 409.

At block 409, the event management unit determines if the filter is a sub-filter. Sub-filters can further refine how events are displayed. Sub-filters inherit attributes (e.g., critieria, permissions, etc.) from higher-level filters and are used to refine the network events that are displayed. For example, a sub-filter for an event type may be added to a filter for a resource name. So, the sub-filter can indicate the event types that should be displayed for the resource name. If the filter is not a sub-fitter, flow continues at block 411. If the filter is a sub-filter, flow continues at block 413.

At block 411, the event management unit adds the filter to the top-level filter view in a filter display panel and flow ends.

At block 413, the event management unit determines the parent filter. The parent filter may be determined based on user input. How continues at block 415.

At block 415, the event management unit adds the filter under the parent filter in the filter view.

Filters are displayed in a hierarchal fashion in the filter display panel. Parent filters are displayed at the top level. Sub-filters are displayed below corresponding parent filters.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that my include a machine-readable medium having stored thereon instructions, which may be used to program a computer system (or other electronic device(s)) to perform a process according to embodiments, whether presently described. or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g,, CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

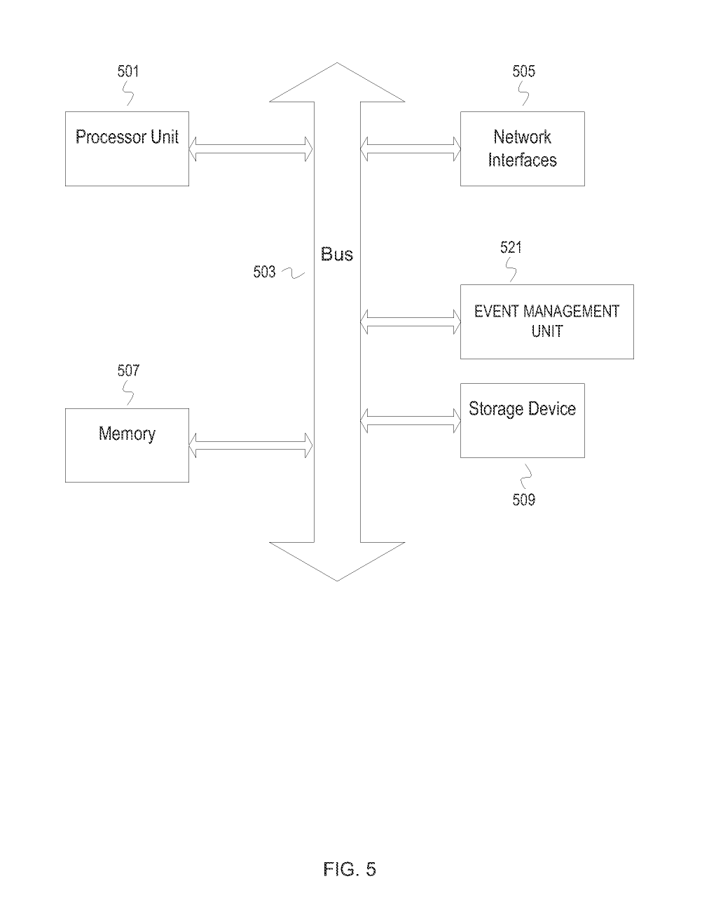

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc., and a storage device(s) 509 (e.g., optical storage, magnetic storage, etc.). The computer system also includes an event management unit 521. The event management unit receives network events, determines if the network events' attributes match criteria indicated in a filter, and displays the network events along a timeline in accordance with the filter. Any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques for enhancing visualization of relationships and temporal proximity between events as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter, in general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving, in an event management unit, a plurality of network events associated with one or more devices on a network;
determining that attributes of the plurality of network events match criteria indicated in one or more filters of the event management unit, wherein the attributes of the network event comprise at least one of a network resource identifier, an event identifier, a time stamp, failure information, topological data, and a network location;
grouping the plurality of network events in accordance with the one or more filters;
determining a first time and a second time for each of the plurality of network events, wherein the first and second times represent, at least one of, arrival of events, status changes, event start times, event end times, first occurrence of events, and last occurrence of events; and
displaying the grouped plurality of network events, in a network event viewer, along a timeline based on the first and second times.

2. The method of claim 1, wherein said displaying the grouped plurality of network events, in the network event viewer, along the timeline based on the first and second times, further comprises presenting the timeline based on a time window, wherein the time window is segmented based on a time interval.

3. The method of claim 2 further comprises: allowing scrolling of the time window to display different time periods of the timeline.

4. The method of claim 3 further comprising: pausing a particular time interval on the timeline based on an indication by a user.

5. The method of claim 1, wherein said displaying the grouped plurality of network events, in the network event viewer, along the timeline based on the first and second times further comprises: color-coding the network events to indicate severity of the network events.

6. The method of claim 1 further comprising: displaying a summary of attributes of a first of the plurality of network events based on indication from a user, wherein the indication comprises at least one of a right-click and a mouse over.
